(19) United States
(12) Patent Application Publication
(10) Pub. No.: US 2025/0173050 A1
(43) Pub. Date: May 29, 2025

(54) DISPLAY DEVICE, DISPLAY METHOD, AND RECORDING MEDIUM RECORDING DISPLAY PROGRAM

(71) Applicant: SHARP KABUSHIKI KAISHA, Osaka (JP)

(72) Inventors: KOUSUKE SUGIURA, Osaka (JP); KOICHI SUGIYAMA, Osaka (JP)

(21) Appl. No.: 18/918,292

(22) Filed: Oct. 17, 2024

(30) Foreign Application Priority Data
Nov. 29, 2023 (JP) 2023-201808

(51) Int. Cl. G06F 3/0484

(52) U.S. Cl. CPC G06F 3/0484

(57) ABSTRACT

A user terminal includes an acquisition processing unit that acquires determination information including at least any one of communication environment information related to a communication environment of each of the plurality of peripheral devices, performance information related to performance of each of the plurality of peripheral devices, and usage environment information related to a usage environment of each of the plurality of peripheral devices, a decision processing unit that decides combinations of the peripheral devices of which the functions are to be enabled based on the determination information, and a display processing unit that displays the combinations of the peripheral devices decided by the decision processing unit on an operation display.

### INCORPORATION BY REFERENCE

This application is based upon and claims the benefit of priority from the corresponding Japanese Patent Application No. 2023-201808 filed on Nov. 29, 2023, the entire contents of which are incorporated herein by reference.

### BACKGROUND

The present disclosure relates to a technique for setting devices (peripheral devices) such as a camera, a microphone, and a speaker used in a display device.

In the related art, a system is known in which devices connected to an information processing apparatus (user terminal) are selectably displayed in a predetermined display order on a settings screen for setting devices (peripheral devices) such as a camera, a microphone, and a speaker used in a web conference.

In a case where a plurality of devices having the same function are connected to the display apparatus (user terminal), a plurality of settable combinations are conceivable. For example, in a case where the display device has a camera, a microphone, and a speaker built therein, and is connected with external devices as a camera, a microphone, and a speaker, a plurality of settable combinations of the cameras, the microphones, and the speakers are conceivable. In such a case, it is difficult for the user to determine which combination is to be set.

### SUMMARY

An object of the present disclosure is to provide a display device, a display method, and a recording medium recording a display program capable of presenting a user with a plurality of combinations of devices settable in the display device.

A display device according to an aspect of the disclosure is a display device capable of using a plurality of devices each having at least one of functions of a camera, a microphone, and a speaker. The display device includes an acquisition processing unit, a decision processing unit, and a display processing unit. The acquisition processing unit acquires determination information including at least any one of communication environment information related to a communication environment of each of the plurality of devices, performance information related to performance of each of the plurality of devices, and usage environment information related to a usage environment of each of the plurality of devices. The decision processing unit decides combinations of the devices of which the functions are to be enabled based on the determination information. The display processing unit displays the combinations of the devices decided by the decision processing unit on the display device.

A display method according to an aspect of the disclosure is a method executed in a device capable of using a plurality of devices each having at least one of functions of a camera, a microphone, and a speaker. The display method is executed by one or more processors and includes acquiring determination information including at least any one of communication environment information related to a communication environment of each of the plurality of devices, performance information related to performance of each of the plurality of devices, and usage environment information related to a usage environment of each of the plurality of devices, deciding combinations of the devices of which the functions are to be enabled based on the determination information, and displaying the combinations of the devices on the display device.

A recording medium according to another aspect of the disclosure is a recording medium recording a program executed in a display device capable of using a plurality of devices each having at least one of functions of a camera, a microphone, and a speaker. The display program is a program causing one or more processors to acquire determination information including at least any one of communication environment information related to a communication environment of each of the plurality of devices, performance information related to performance of each of the plurality of devices, and usage environment information related to a usage environment of each of the plurality of devices, decide combinations of the devices of which the functions are to be enabled based on the determination information, and display the combinations of the devices on the display device.

According to the disclosure, it is possible to provide a display device, a display method, and a recording medium recording a display program capable of presenting a user with a plurality of combinations of devices settable in the display device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram illustrating a configuration of a display system according to an embodiment of the disclosure.

FIG. 2 is a diagram illustrating an example of a settings screen displayed in a user terminal in the related art.

FIG. 3 is a diagram illustrating an example of device information stored in a data server according to the embodiment of the disclosure.

FIG. 4 is a diagram illustrating an example of a settings screen displayed in a user terminal according to the embodiment of the present disclosure.

FIG. 5 is a diagram illustrating an example of a combination selection screen displayed in the user terminal according to the embodiment of the present disclosure.

FIG. 6 is a diagram illustrating an example of a settings screen displayed in the user terminal according to the embodiment of the present disclosure.

FIG. 7 is a diagram illustrating an example of the settings screen displayed in the user terminal according to the embodiment of the present disclosure.

FIG. 8 is a diagram illustrating an example of the settings screen displayed in the user terminal according to the embodiment of the present disclosure.

FIG. 9 is a diagram illustrating an example of the settings screen displayed in the user terminal according to the embodiment of the present disclosure.

FIG. 10 is a flowchart illustrating an example of a procedure of device setting processing executed in the user terminal according to the embodiment of the present disclosure.

### DETAILED DESCRIPTION

Embodiments of the disclosure will be described below with reference to the drawings. Note that the following embodiments are specific examples of the disclosure, and do not limit the technical scope of the disclosure.

A display system according to the present disclosure can be applied to, for example, a case in which a plurality of users perform an online conference (such as a Web conference) using respective user terminals and devices such as cameras, microphones, and speakers. The camera, the microphone, and the speaker are peripheral devices connected to or built in the user terminal. Each user can activate a predetermined application (such as a conference application) on the user terminal of the user and set a camera, a microphone, and a speaker to have a conversation by transmitting and receiving video and audio. The device according to the disclosure may be a device built in the user terminal or a device connected to the user terminal in a wired or wireless manner.

### Display System 10

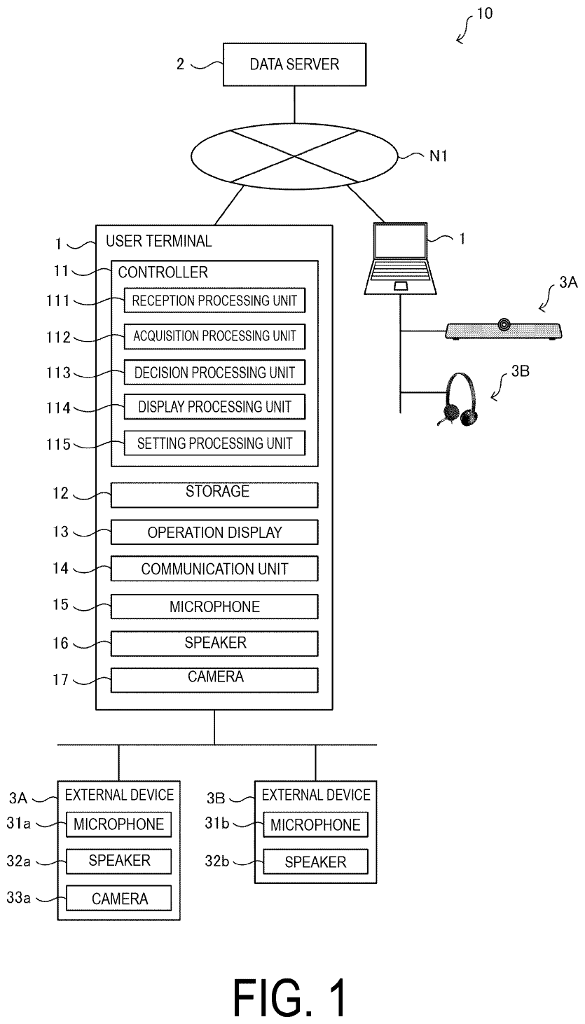

FIG. 1 is a diagram illustrating a configuration of a display system 10 according to an embodiment of the disclosure. The display system 10 includes a user terminal 1, a server 2, and external devices 3 (external devices 3A and 3B in FIG. 1). The display system 10 includes one or more user terminals 1. The peripheral devices may be connected to the user terminal 1 in a wired or wireless manner, or may be built in the user terminal 1. In the example illustrated in FIG. 1, a microphone 15, a speaker 16, and a camera 17 are built in the user terminal 1. In addition, the external device 3A (camera microphone and speaker device) including a microphone 31a, a speaker 32a, and a camera 33a, and the external device 3B (microphone and speaker device) including a microphone 31b and a speaker 32b are connected to the user terminal 1 in a wired or wireless manner. The number of external devices connected to the user terminal 1 is not limited to two, and may be one or three or more.

The data server 2 is a storage device that stores various types of information. The user terminal 1 and the server 2 can communicate with each other via a network N1 such as the Internet, a LAN, a WAN, or a public phone line. For example, the data server 2 includes a cloud server.

The camera (camera 17, camera 33a) is a digital camera that captures an image of a subject and outputs the captured image as a digital image. The image data captured by the camera is transmitted to a controller 11 of the user terminal 1. For example, the camera captures an image of a predetermined area including the user using the user terminal 1.

The microphones (the microphone 15, the microphone 31a, and the microphone 31b) collect voice audio uttered by the user of the user terminal 1 and transmit data of the audio to the controller 11 of the user terminal 1. The speakers (the speaker 16, the speaker 32a, and the speaker 32b) output (emit) audio data transmitted from other user terminals 1.

The display system 10 may include a conference server that executes a conference application for an online conference. The conference server manages conference information. Each user terminal 1 activates the conference application and transmits and receives video and audio via the conference server. The allows the plurality of users to perform an online conference.

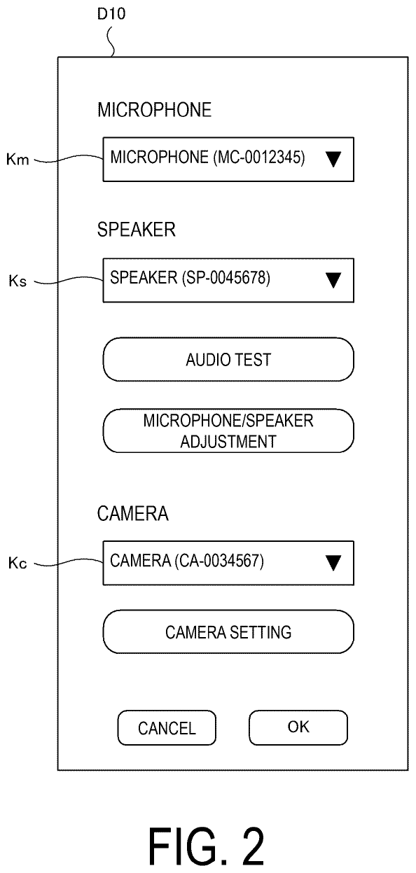

Here, each user, when performing an online conference, performs an operation of setting a peripheral device for the user to use. For example, the user activates the conference application in the user terminal 1 and performs an operation of setting the microphone, the speaker, and the camera on a settings screen. FIG. 2 shows an example of a settings screen D10 in the related art. The settings screen D10 illustrated in FIG. 2 includes a microphone setting field Km for setting a microphone, a speaker setting field Ks for setting a speaker, and a camera setting field Kc for setting a camera. The user presses (clicks) the microphone setting field Km on the settings screen D10 to select a microphone to be used from one or more microphones displayed in a microphone list. The user presses (clicks) the speaker setting field Ks on the settings screen D10 to select a speaker to be used from one or more speakers displayed in a speaker list. The user presses (clicks) the camera setting field Kc on the settings screen D10 to select a camera to be used from one or more cameras displayed in a camera list.

Here, in a case where a plurality of devices (peripheral devices) having the same function are connected to the user terminal 1, a plurality of settable combinations are conceivable. For example, in a case where the user terminal 1 has a camera, a microphone, and a speaker built therein, and is connected with external devices as a camera, a microphone, and a speaker, a plurality of settable combinations of the cameras, the microphones, and the speakers are conceivable. In such a case, it is difficult for the user to determine which combination is to be set. In contrast, the user terminal 1 according to the present embodiment has a configuration capable of presenting the user with a plurality of combinations of the peripheral devices settable in the user terminal 1 as described below.

### User Terminal 1

As illustrated in FIG. 1, the user terminal 1 is an information processing apparatus including the controller 11, a storage 12, an operation display 13, a communication unit 14, the microphone 15, the speaker 16, the camera 17, and the like. The user terminal 1 is a personal computer or a smartphone, for example. The user terminal 1 is an example of the display device of the disclosure.

The communication unit 14 is a communication unit for the user terminal 1 to execute, in a wired or wireless manner, data communication with a peripheral device such as the external devices 3A and 3B in accordance with a predetermined communication protocol. The communication unit 14 is a communication interface for connecting the user terminal 1 to the communication network N1 in a wired or wireless manner and executing data communication in accordance with a predetermined communication protocol with an external device such as the data server 2 via the communication network N1.

The operation display 13 is a user interface including a display such as a liquid crystal display or an organic electroluminescent (EL) display that displays various types of information, and an operation unit such as a mouse, a keyboard, or a touch panel that receives an operation.

The storage 12 is a non-volatile storage such as a hard disk drive (HDD), a solid state drive (SSD), or a flash memory that stores various types of information. Specifically, the storage 12 stores information related to the peripheral devices such as a microphone, a camera, and a speaker.

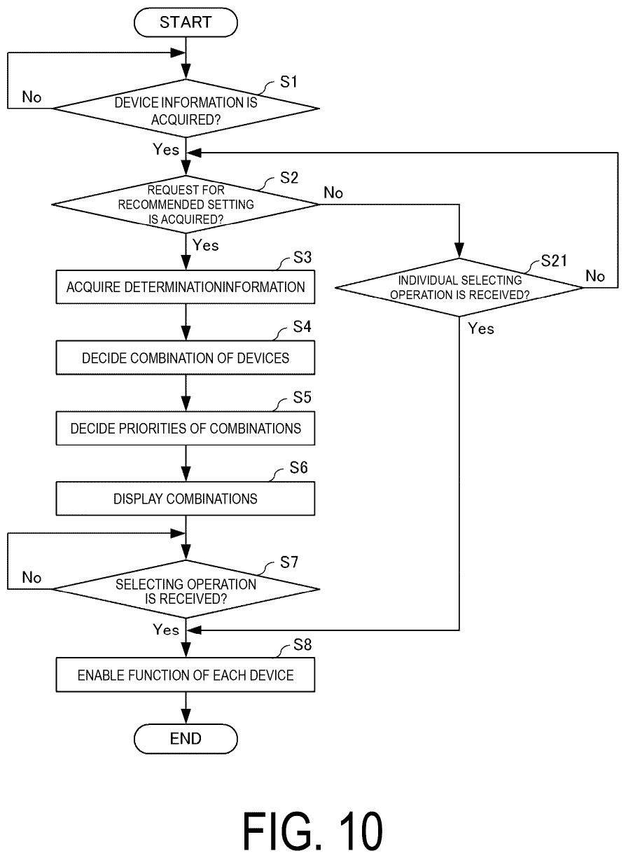

The storage 12 stores a control program such as a device setting program for causing the controller 11 to execute the device setting processing described below (see FIG. 10). For example, the device setting program is non-temporarily recorded in a computer-readable recording medium such as a CD or a DVD, read by a reading device (not illustrated) such as a CD drive or a DVD drive included in the user terminal 1, and stored in the storage 12.

The controller 11 includes control devices such as a central processing unit (CPU), a read only memory (ROM), and a random access memory (RAM). The CPU is a processor that executes various types of arithmetic processing. The ROM is non-volatile storage that stores, in advance, control programs such as a basic input/output system (BIOS) and an operating system (OS) for causing the CPU to execute various types of calculation processing. The RAM is a volatile or non-volatile storage that stores various types of information and is used as a temporary storage memory (work area) for the various types of processing executed by the CPU. Then, the controller 11 controls the user terminal 1 by causing the CPU to execute various types of the control programs stored in advance in the ROM or the storage 12.

Specifically, the controller 11 includes various processing units such as a reception processing unit 111, an acquisition processing unit 112, a decision processing unit 113, a display processing unit 114, and a setting processing unit 115. Note that the controller 11 functions as the various types of processing units by executing various types of processing in accordance with the control program using the CPU. Further, some or all of the processing units may be constituted by an electronic circuit. Note that the control programs may be programs for causing multiple processors to function as the processing units.

The reception processing unit 111 receives various operations of a user. For example, the reception processing unit 111 receives a setting operation for peripheral devices to be used for an online conference from the user.

The acquisition processing unit 112 acquires identification information (model number, device number, product number, or the like) of the peripheral devices connected to the user terminal 1. For example, when the microphones 15, 31a, 31b, the speakers 16, 32a, 32b, and the cameras 17, 33a are connected to (such as, built in, connected by wire to, connected by wireless to) the user terminal 1, the acquisition processing unit 112 acquires the identification information of each microphone, the identification information of each speaker, and the identification information of each camera.

The acquisition processing unit 112 searches for and acquires device information corresponding to each relevant peripheral device via the network based on the identification information of the peripheral device. To be more specific, the acquisition processing unit 112 transmits a search request including the device information of the peripheral device to the server 2 via the Internet (the communication network N1). Here, the acquisition processing unit 112 transmits a search request including identification information of each of the microphones 15, 31a, 31b, the speakers 16, 32a, 32b, and the cameras 17, 33a to the database server 2.

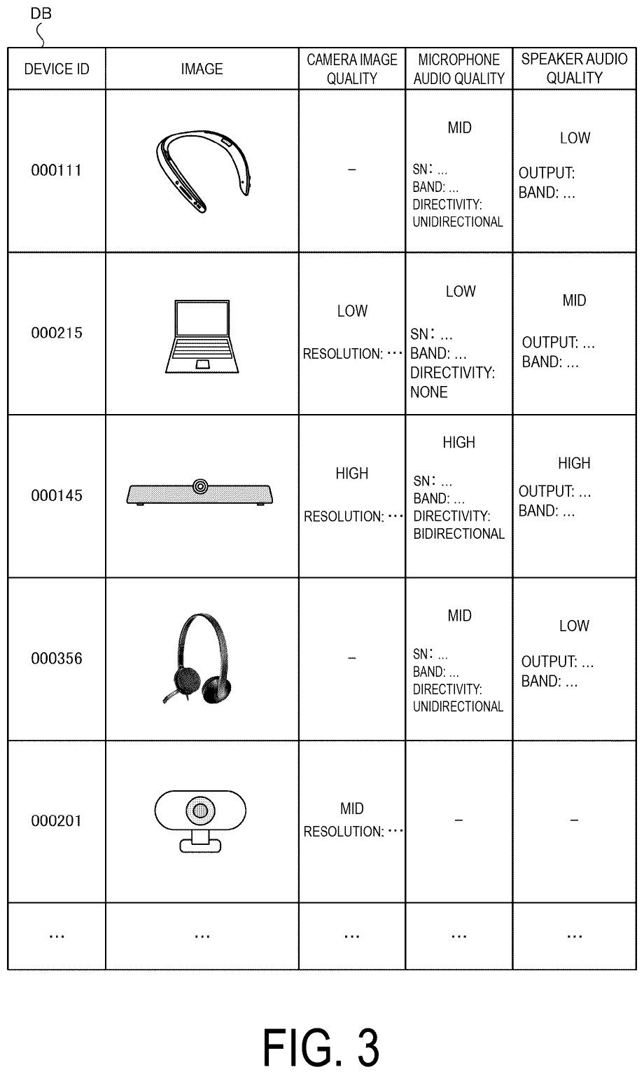

The data server 2 searches the device information stored in the storage (database DB) for the device information corresponding to the search request. FIG. 3 illustrates an example of the database DB. As illustrated in FIG. 3, the database DB stores information of various peripheral devices. The device information includes images (photographs, still images, moving images, and the like) of the device, performance information (camera image quality, microphone audio quality, speaker audio quality, or the like) of the device, and the like. The data server 2 may search for a microphone image matching or similar to the identification information of each microphone, search for a speaker image matching or similar to the identification information of each speaker, and search for a camera image matching or similar to the identification information of each camera. The data server 2 transmits a search result (device information) to the user terminal 1. The acquisition processing unit 112, upon acquiring the device information from the data server 2, stores the device information in the storage 12.

In this way, the acquisition processing unit 112 acquires the performance information related to the performance of each of the plurality of peripheral devices. For example, the acquisition processing unit 112 acquires information related to a resolution of each camera, a sensitivity, frequency band, and directivity of each microphone, and an output level and frequency band of each speaker.

The acquisition processing unit 112 unit acquires communication environment information related to a communication environment of the peripheral device. Specifically, the acquisition processing unit 112 acquires information related to a communication band and communication speed of each of the microphones, the speakers, and the cameras. The acquisition processing unit 112 acquires the current communication environment information by performing data communication with each peripheral device. The acquisition processing unit 112 acquires the current communication environment information of the network (communication network N1) to which the user terminal 1 is connected.

The acquisition processing unit 112 acquires usage environment information related to a usage environment of the peripheral device. Specifically, the acquisition processing unit 112 acquires information related to a size of a conference room for a conference in which the peripheral devices are used, the number and attributes of participants who participate in the conference, and a type of the conference. The acquisition processing unit 112 acquires the usage environment information with reference to conference reservation information registered in a conference server (not illustrated), for example.

In the present embodiment, the acquisition processing unit 112 acquires determination information including at least any one of the performance information related to the performance of each of the plurality of peripheral devices, the communication environment information related to the communication environment of each of the plurality of peripheral devices, and the usage environment information related to the usage environment of each of the plurality of peripheral devices.

The decision processing unit 113 decides a combination of the peripheral devices of which the functions are to be enabled based on the determination information acquired by the acquisition processing unit 112. For example, in a case where the microphone 15 built in the user terminal 1, the microphone 31a of the external device 3A connected to the user terminal 1, and the microphone 31b of the external device 3B connected to the user terminal 1 are available to the user terminal 1, the decision processing unit 113 decides any one of the microphones based on the determination information. For example, in a case where the speaker 16 built in the user terminal 1, the speaker 32a of the external device 3A connected to the user terminal 1, and the speaker 32b of the external device 3B connected to the user terminal 1 are available to the user terminal 1, the decision processing unit 113 decides any one of the speakers based on the determination information. For example, in a case where the camera 17 built in the user terminal 1 and the camera 33a of the external device 3A are available to the user terminal 1, the decision processing unit 113 decides any one of the cameras based on the determination information.

Further, the decision processing unit 113 decides a combination of a microphone, a speaker, and a camera which can be used together. In addition, for example, in a case where there are two peripheral devices (camera devices) having the same function (for example, a camera), if the same function is duplicated when the functions of the respective peripheral devices are set to be enabled, the decision processing unit 113 excludes the combination of the two peripheral devices.

The decision processing unit 113 decides a combination of a microphone, a speaker, and a camera based on, for example, the performance information related to a resolution of each camera, a sensitivity, frequency band, and directivity of each microphone, and an output level and frequency band of each speaker. For example, the decision processing unit 113 decides a combination of a microphone, a speaker, and a camera capable of realizing high image quality and high audio quality, a combination of a microphone, a speaker, and a camera capable of realizing high image quality and low audio quality, a combination of a microphone, a speaker, and a camera capable of realizing middle image quality and middle audio quality, a combination of a microphone, a speaker, and a camera capable of realizing low image quality and middle audio quality, a combination of a microphone, a speaker, and a camera capable of realizing low image quality and low audio quality, and the like.

As another embodiment, the decision processing unit 113 decides a combination of a microphone, a speaker, and a camera, for example, based on the communication environment information related to a communication band and communication speed of each of the microphones, the speakers, and the cameras. For example, the decision processing unit 113 decides a combination of a microphone, a speaker, and a camera corresponding to the communication band of the current communication network N1.

As another embodiment, the decision processing unit 113 decides a combination of a microphone, a speaker, and a camera based on the usage environment information related to a size of a conference room for a conference in which the peripheral devices are used, the number and attributes of participants who participate in the conference, and a type of the conference. For example, the decision processing unit 113 decides a combination of a microphone, a speaker, and a camera corresponding to dimensions of a conference room.

The decision processing unit 113 may decide a combination of a microphone, a speaker, and a camera based on at least any one of the performance information, the communication environment information, and the usage environment information.

The decision processing unit 113 decides priorities of the combinations of the peripheral devices based on the determination information. For example, the decision processing unit 113 decides the priorities of the combinations of microphones, speakers, and cameras in descending order of the performance (image quality and audio quality) of the peripheral device. The decision processing unit 113 decides the priorities of the combinations of microphones, speakers, and cameras in descending order of the communication speed or communication band of the peripheral device. The decision processing unit 113 may calculate an evaluation value for each combination for each of the performance information, the communication environment information, and the usage environment information, and may decide the priority of each combination based on the sum of the evaluation values of the respective pieces of information.

As described above, in the present embodiment, in a case where the user terminal 1 is capable of using a first device and a second device both of which have a first function of functions of a camera, a microphone, and a speaker, and a third device and a fourth device both of which have a second function of the functions of the camera, the microphone, and the speaker, the second function being different from the first function, the decision processing unit 113 decides a combination of either one of the first and second devices of which the first function is enabled and either one of the third and fourth devices of which the second function is enabled based on the determination information. For example, in a case where the user terminal 1 is capable of using the user terminal 1 and the external device 3A which include a camera, and the external device 3A and the external device 3B which include a microphone, the decision processing unit 113 decides a combination of a device that is either one of the user terminal 1 and the external device 3A of which the camera is enabled and a device that is either one of the external device 3A and the external device 3B of which the microphone is enabled based on the determination information.

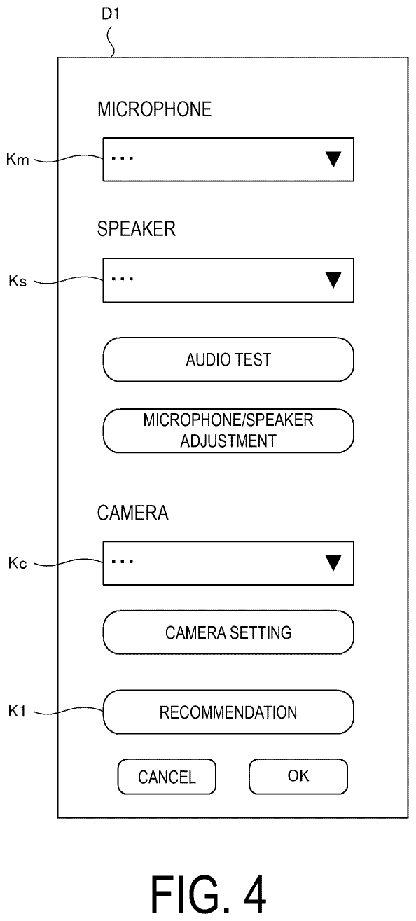

The display processing unit 114 display a settings screen for setting the peripheral devices on the operation display 13. To be specific, the display processing unit 114 displays a settings screen D1 illustrated in FIG. 4 on the operation display 13, and displays the microphone setting field Km, the speaker setting field Ks, and the camera setting field Kc on the settings screen D1. The user can select a peripheral device (microphone, speaker, camera, or the like) to be used on the settings screen D1.

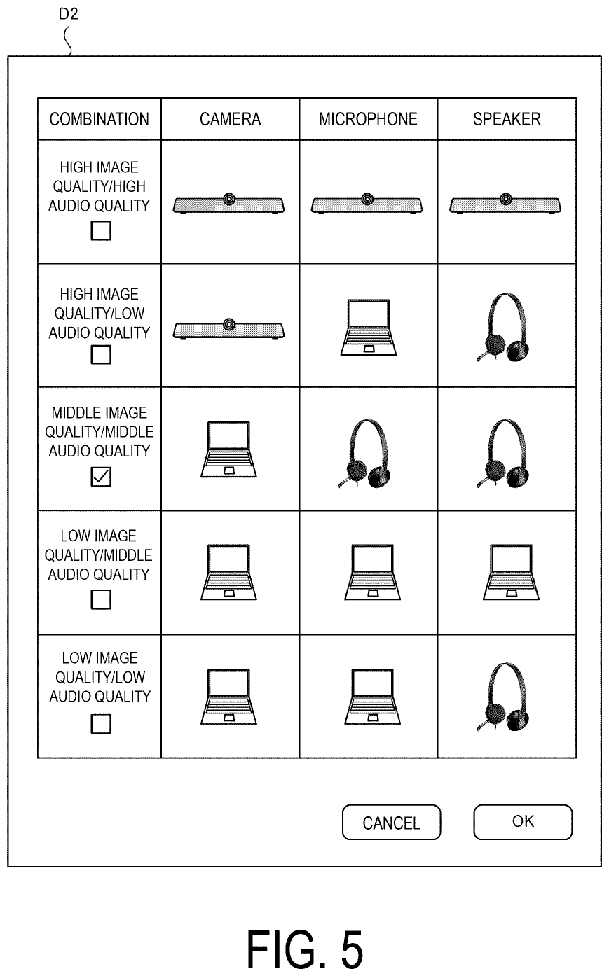

The display processing unit 114 displays the combinations of the peripheral devices decided by the decision processing unit 113 on the operation display 13. To be specific, the display processing unit 114 displays a “recommendation” button K1 on the settings screen D1 (see FIG. 4). When the user presses the “recommendation” button K1, the display processing unit 114 displays a combination selection screen D2 (see FIG. 5) related to the combination of the peripheral devices decided by the decision processing unit 113. On the combination selection screen D2, a plurality of combinations of microphones, speakers, and cameras decided by the decision processing unit 113 are displayed in accordance with the priorities. FIG. 5 illustrates an example in which a plurality of combinations are displayed in descending order of the image quality and audio quality. Note that the display processing unit 114 displays information of the combination of the microphone, the speaker, and the camera as an image (device images). Thus, the user can intuitively recognize the peripheral devices. The user can select one of the combinations on the combination selection screen D2. FIG. 5 illustrates a state in which a combination for “middle image quality/middle audio quality is selected.

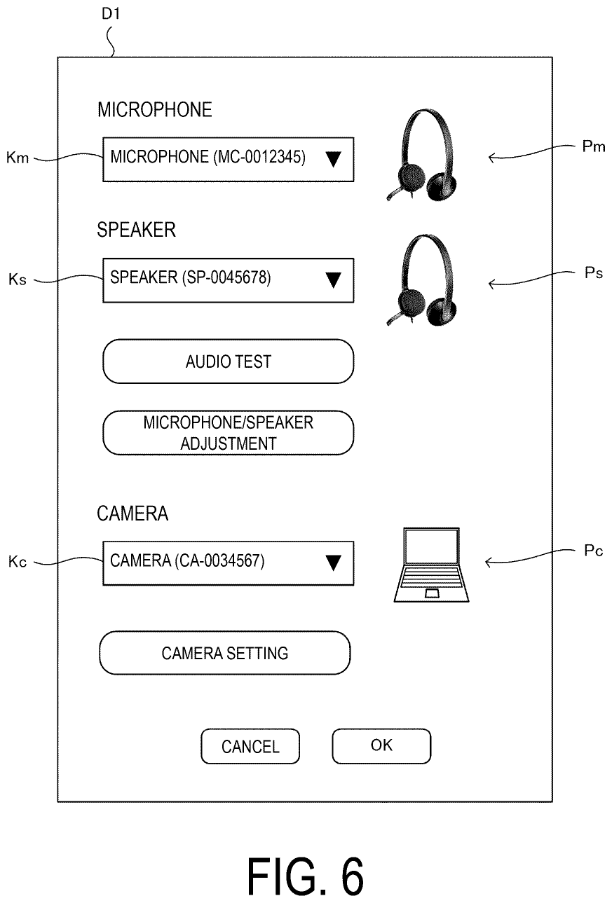

When the user selects one of the combinations on the combination selection screen D2 and presses an OK button, the display processing unit 114 displays information of the peripheral devices included in the selected combination on the settings screen D1 (see FIG. 6). For example, when the user selects the combination for “middle image quality/middle audio quality”, the display processing unit 114 displays, as illustrated in FIG. 6, the identification information of the microphone 31b of the external device 3B included in the combination of “middle image quality/middle audio quality” in the microphone setting field Km, and displays a microphone image Pm corresponding to the identification information of the microphone 31b in association with the identification information. In addition, the display processing unit 114 displays the identification information of the speaker 32b of the external device 3B included in the combination of “middle image quality/middle audio quality” in the speaker setting field Ks, and displays a speaker image Ps corresponding to the identification information of the speaker 32b in association with the identification information. In addition, the display processing unit 114 displays the identification information of the camera 17 of the user terminal 1 included in the combination of “middle image quality/middle audio quality” in the camera setting field Kc, and displays a camera image Pc corresponding to the identification information of the camera 17 in association with the identification information.

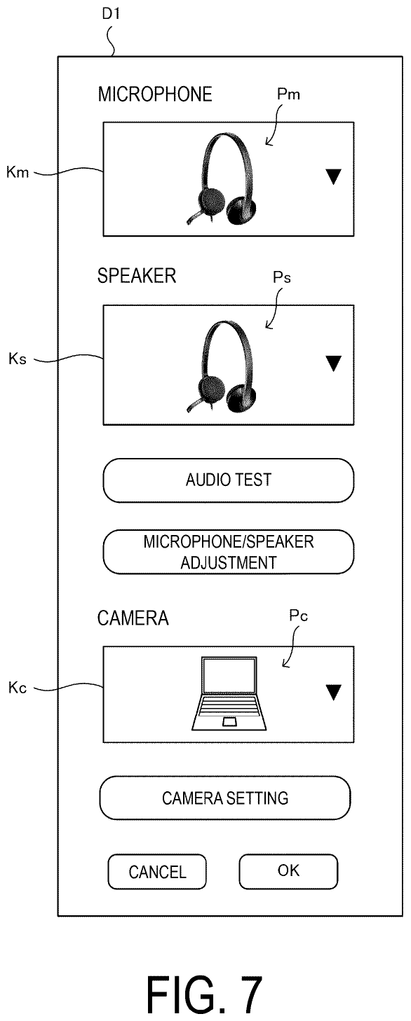

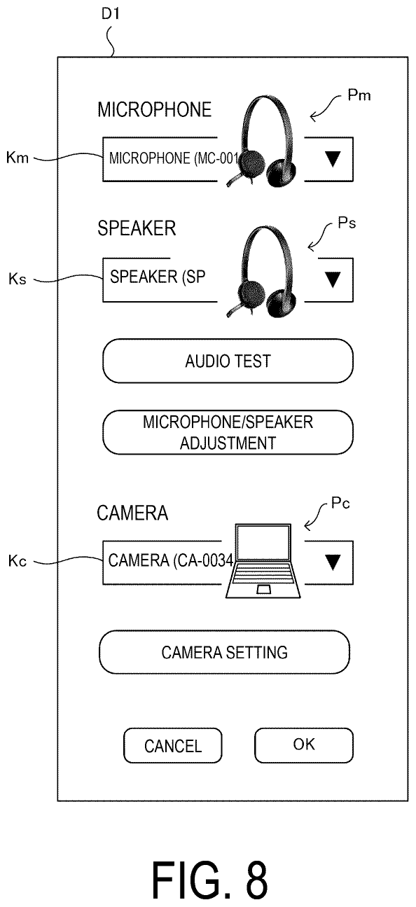

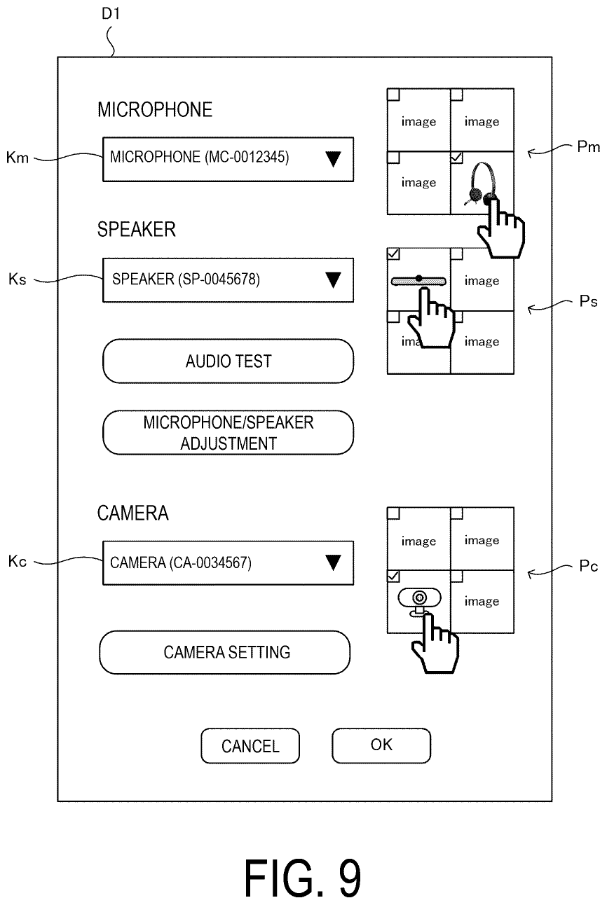

Note that the display processing unit 114 may display the device images side by side with the identification information as illustrated in FIG. 6, may display the device images instead of the identification information as illustrated in FIG. 7, or may display the device images overlapping the identification information as illustrated in FIG. 8. Further, as illustrated in FIG. 9, the user may be able to change the displayed device on the settings screen D1. For example, the user may press the speaker setting field Ks on the settings screen D1 to change the speaker. In this case, the controller 11 may selectably display one or more changeable speakers (see FIG. 9).

The setting processing unit 115 sets the function of the peripheral device selected by the user to be enabled. To be specific, the setting processing unit 115 sets the function of the peripheral device in the combination selected by the user from among the combinations of the peripheral devices displayed on the combination selection screen D2 (see FIG. 5) to be enabled. For example, when the user presses the OK button in a state where the information of the microphone, the speaker, and the camera corresponding to the combination selected by the user is displayed on the settings screen D1 illustrated in FIG. 6, the setting processing unit 115 enables the displayed microphone, speaker, and camera.

This allows the user to perform a conference by using the peripheral devices set to be enabled. In the example illustrated in FIG. 6, when a conference is started, conference audio is transmitted and received by the microphone and the speaker of the external device 3B, and a captured image is transmitted by the camera 17 built in the user terminal 1.

As another embodiment, the controller 11 may be able to change the peripheral device based on at least any one of the performance information, the communication environment information, and the usage environment information after the conference is started (for example, during the conference). For example, in a case where the communication speed decreases during the conference, the controller 11 may display a combination of a microphone, a speaker, and a camera corresponding to a low communication speed and receive an operation of selecting a desired combination from the user. In a case that the user selects a combination, the controller 11 disables the microphone, the speaker, and the camera that are currently set to be enabled, and sets the microphone, the speaker, and the camera in the selected combination to be enabled. As a result, the user does not need to switch each peripheral device by the user, and can recognize and switch to the optimum combination of the peripheral devices.

### Device Setting Processing

Hereinafter, an example of a procedure of the device setting processing executed by the controller 11 of the user terminal 1 will be described with reference to FIG. 10.

Note that the disclosure can be regarded as the disclosure of a device setting method (the display method of the disclosure) that executes one or more steps included in the device setting processing. The one or more steps included in the device setting processing described herein may be omitted as appropriate. Each of the steps in the device setting processing may be executed in a different order as far as the same effect is obtained. Furthermore, here, a case in which the controller 11 executes each of the steps in the device setting processing will be described as an example, but in another embodiment, one or more processors may execute each of the steps in the device setting processing in a distributed manner.

First, in step S1, the controller 11 determines whether the identification information (model number, device number, product number, or the like) of the peripheral device has been acquired. For example, when the controller 11 recognizes a microphone, a speaker, and a camera connected to the user terminal 1, the controller 11 acquires identification information of each peripheral device. For example, when the user selects the identification information of the peripheral device on the settings screen D1 (see FIG. 4), the controller 11 may acquire the identification information of the selected peripheral device. Once the controller 11 acquires the identification information of the peripheral device (S1: Yes), the controller 11 shifts the processing to step S2. The controller 11 awaits until the identification information of the peripheral device is acquired (S1: No).

In step S2, the controller 11 determines whether a request for a “recommended” setting for a setting for enabling each peripheral device has been received from the user. For example, when the user presses the “recommendation” button K1 on the settings screen D1 illustrated in FIG. 4, the controller 11 receives the request for the “recommendation” setting (S2: Yes), and shifts the processing to step S3. For example, when the user presses the “recommendation” button K1 on the settings screen D1 illustrated in FIG. 4, the controller 11, if the request for the “recommendation” setting is not received (S2: No), shifts the processing to step S21.

In step S3, the controller 11 acquires the determination information for deciding a combination of the peripheral devices. Specifically, the controller 11 acquires the determination information including at least any one of the communication environment information related to the communication environment of each of the plurality of peripheral devices, the performance information related to the performance of each of the plurality of peripheral devices, and the usage environment information related to the usage environment of each of the plurality of peripheral devices. For example, the controller 11 acquires the performance information related to a resolution of each camera, a sensitivity, frequency band, and directivity of each microphone, and an output level and frequency band of each speaker from the data server 2. The controller 11 acquires the communication environment information related to the communication band and communication speed of each of the microphones, the speakers, and the cameras based on a data communication state between the user terminal 1 and the external device. The controller 11 acquires, from the conference server, the usage environment information related to a size of a conference room for a conference in which the peripheral devices are used, the number and attributes of participants who participate in the conference, and a type of the conference.

Next, in step S4, the controller 11 decides combinations of the peripheral devices of which the functions are to be enabled based on the determination information.

For example, the controller 11 decides a combination of a microphone, a speaker, and a camera based on the performance information related to a resolution of each camera, a sensitivity, frequency band, and directivity of each microphone, and an output level and frequency band of each speaker.

For example, the controller 11 decides a combination of a microphone, a speaker, and a camera, for example, based on the communication environment information related to a communication band and communication speed of each of the microphones, the speakers, and the cameras.

For example, the controller 11 decides a combination of a microphone, a speaker, and a camera based on the usage environment information related to a size of a conference room for a conference in which the peripheral devices are used, the number and attributes of participants who participate in the conference, and a type of the conference.

The controller 11 may decide a combination of a microphone, a speaker, and a camera based on at least any one of the performance information, the communication environment information, and the usage environment information.

Next, in step S5, the controller 11 decides priorities of the combinations based on the determination information. For example, the controller 11 decides the priorities of the combinations of microphones, speakers, and cameras in descending order of the performance (image quality and audio quality) of the peripheral device. The controller 11 decides the priorities of the combinations of microphones, speakers, and cameras in descending order of the communication speed or communication band of the peripheral device.

Next, in step S6, the controller 11 displays the combinations of the peripheral devices determined in step S4 in accordance with the priorities decided in step S5. For example, on the combination selection screen D2 illustrated in FIG. 5, the controller 11 displays the information of the combinations of microphones, speakers, and cameras as the images of the devices in descending order of the image quality and the audio quality.

Next, in step S7, the controller 11 determines whether an operation of selecting a specific combination among the plurality of combinations has been received from the user. In a case that the user selects one combination (selects a check box) on the combination selection screen D2, the controller 11 shifts the processing to step S8. The controller 11 awaits until the operation of selecting a combination is received from the user (S7: No).

In step S8, the controller 11 sets the functions of the microphone, the speaker, and the camera corresponding to the combination selected by the user to be enabled. To be more specific, when the user selects one combination on the combination selection screen D2, the controller 11 displays information of the microphone, the speaker, and the camera corresponding to the combination selected by the user together with images of the respective devices on the settings screen D1 (see FIG. 6). When the user presses the OK button on the settings screen D1, the controller 11 sets the functions of the microphone, the speaker, and the camera to be enabled.

Note that in step S2, in a case that the request for the “recommended” setting is not received from the user, the controller 11 determines whether an operation of individually setting each peripheral device is received in step S21. For example, on the settings screen D1 illustrated in FIG. 4, the user can individually select each of the microphone, the speaker, and the camera. In a case where the user individually selects each of the microphone, the speaker, and the camera (S21: Yes), the controller 11 sets each of the functions of the microphone, the speaker, and the camera to be enabled in accordance with the individual setting operation of the user (S8).

When the setting processing of the peripheral device to be used by the user in the conference is completed as described above, the controller 11 starts an online conference using the set peripheral devices. Each user terminal 1 executes the above-described device setting processing in parallel before starting the online conference.

As described above, the user terminal 1 according to the present embodiment can use a plurality of devices having at least one of functions of a camera, a microphone, and a speaker. The user terminal 1 acquires the determination information including at least any one of the communication environment information related to the communication environment of each of the plurality of devices, the performance information related to the performance of each of the plurality of devices, and the usage environment information related to the usage environment of each of the plurality of devices, decides the combinations of the devices of which the functions are to be enabled based on the determination information, and displays the combinations of the devices on the user terminal 1.

For example, the user terminal 1 decides the priorities of the combinations bases on the determination information, and displays the combinations based on the priorities. Then, the user terminal 1 sets the functions of the devices in the combination selected by the user among the displayed combinations of the devices to be enabled.

According to the above configuration, in a case where a plurality of peripheral devices (microphone, speaker, camera, and the like) having the same function are connected to the user terminal 1, it is possible to present the user with a plurality of combinations of the peripheral devices settable in the user terminal 1. Since the optimum combination of the plurality of peripheral devices is presented to the user, the user does not need to select a peripheral device for each function and can set the plurality of peripheral devices by selecting the optimum combination. Therefore, the user's time and effort can be saved, and usability is improved.

The present disclosure may be configured by the user terminal 1 alone or may be configured by the controller 11 (control device) of the user terminal 1 alone.

### Supplementary Notes of Disclosure

Hereinafter, an outline of the disclosure extracted from the above-described embodiments will be described as supplementary notes. Note that configurations and processing functions described in the following supplementary notes can be selected and combined as desired.

### Supplementary Note 1

A display device capable of using a plurality of devices each having at least one of functions of a camera, a microphone, and a speaker, the display device including:
an acquisition processing circuit that acquires determination information including at least any one of communication environment information related to a communication environment of each of the plurality of devices, performance information related to performance of each of the plurality of devices, and usage environment information related to a usage environment of each of the plurality of devices;
a decision processing circuit that decides combinations of the devices of which the functions are to be enabled based on the determination information; and
a display processing circuit that displays the combinations of the devices decided by the decision processing circuit on the display device.

### Supplementary Note 2

The display device according to supplementary note 1, wherein
the decision processing circuit decides priorities of the combinations based on the determination information, and
the display processing circuit displays the combinations based on the priorities on the display device.

### Supplementary Note 3

The display device according to supplementary note 1 or 2, further including:
a setting processing circuit that sets the functions of the devices, to be enabled, in the combination selected by a user from among the combinations of the devices displayed on the display device.

### Supplementary Note 4

The display device according to any one of supplementary notes 1 to 3, wherein
the display processing circuit displays the combinations with device images corresponding to the devices on the display device.

### Supplementary Note 5

The display device according to according to supplementary note 4, wherein the acquisition processing circuit acquires images corresponding to the devices via a network based on identification information of the devices, and
the display processing circuit displays the device images corresponding to the devices in association with the identification information based on images acquired by the acquisition processing circuit.

### Supplementary Note 6

The display device according to any one of supplementary notes 1 to 5, wherein in a case where the display device is capable of using a first device and a second device both of which have a first function of the functions of the camera, the microphone, and the speaker, and a third device and a fourth device both of which have a second function of the functions of the camera, the microphone, and the speaker, the second function being different from the first function,
the decision processing circuit decides a combination of either one of the first and second devices of which the first function is enabled and either one of the third and fourth devices of which the second function is enabled based on the determination information.

### Supplementary Note 7

The display device according to any one of supplementary notes 1 to 6, wherein the communication environment information includes information related to a communication band and a communication speed,
the performance information includes information related to a resolution of the camera, a sensitivity, frequency band, and directivity of the microphone, and an output level and frequency band of the speaker, and
the usage environment information includes information related to a size of a conference room for a conference in which the devices are used, the number and attributes of participants who participate in the conference, and a type of the conference.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A display device capable of using a plurality of devices each having at least one of functions of a camera, a microphone, and a speaker, the display device comprising:
one or more processors, wherein
the one or more processors
acquire determination information including at least any one of communication environment information related to a communication environment of each of the plurality of devices, performance information related to performance of each of the plurality of devices, and usage environment information related to a usage environment of each of the plurality of devices,
decide combinations of the devices of which the functions are to be enabled based on the determination information, and
display the combinations of the devices on the display device.

2. The display device according to claim 1, wherein
the one or more processors decide priorities of the combinations based on the determination information, and display the combinations based on the priorities on the display device.

3. The display device according to claim 1, wherein
the one or more processors set the functions of the devices, to be enabled, in a combination selected by a user from among the combinations of the devices displayed on the display device.

4. The display device according to claim 1, wherein
the one or more processors display the combinations with device images corresponding to the devices on the display device.

5. The display device according to claim 4, wherein
the one or more processors acquire images corresponding to the devices via a network based on identification information of the devices, and display the device images corresponding to the devices in association with the identification information based on the acquired images.

6. The display device according to claim 1, wherein
in a case where the display device is capable of using a first device and a second device both of which have a first function of the functions of the camera, the microphone, and the speaker, and a third device and a fourth device both of which have a second function of the functions of the camera, the microphone, and the speaker, the second function being different from the first function,
the one or more processors decide a combination of either one of the first and second devices of which the first function is enabled and either one of the third and fourth devices of which the second function is enabled based on the determination information.

7. The display device according to claim 1, wherein
the communication environment information includes information related to a communication band and a communication speed,
the performance information includes information related to a resolution of the camera, a sensitivity, frequency band, and directivity of the microphone, and an output level and frequency band of the speaker, and
the usage environment information includes information related to a size of a conference room for a conference in which the devices are used, the number and attributes of participants who participate in the conference, and a type of the conference.

8. A display method executed in a device capable of using a plurality of devices each having at least one of functions of a camera, a microphone, and a speaker, the display method comprising:
acquiring determination information including at least any one of communication environment information related to a communication environment of each of the plurality of devices, performance information related to performance of each of the plurality of devices, and usage environment information related to a usage environment of each of the plurality of devices;
deciding combinations of the devices of which the functions are to be enabled based on the determination information; and
displaying the combinations of the devices on the display device.

9. A non-transitory computer-readable recording medium recording a display program executed in a display device capable of using a plurality of devices each having at least one of functions of a camera, a microphone, and a speaker, the display program causing one or more processors to:
acquire determination information including at least any one of communication environment information related to a communication environment of each of the plurality of devices, performance information related to performance of each of the plurality of devices, and usage environment information related to a usage environment of each of the plurality of devices,
decide combinations of the devices of which the functions are to be enabled based on the determination information, and
display the combinations of the devices on the display device.
